(19) United States
(12) Patent Application Publication
(10) Pub. No.: US 2026/0143341 A1
(43) Pub. Date: May 21, 2026

(54) RULE-BASED SYSTEM THAT RESTRICTS A USER DEVICE BASED ON A DETECTED CONDITION

(71) Applicant: Analog LLC, Provo, UT (US)

(72) Inventor: John William HYDE, Provo, UT (US)

(21) Appl. No.: 19/380,604

(22) Filed: Nov. 5, 2025

Related U.S. Application Data
(60) Provisional application No. 63/723,368, filed on Nov. 21, 2024.

(51) Int. Cl. H04W 12/08; H04W 12/61; H04W 12/63

(52) U.S. Cl. CPC H04W 12/08; H04W 12/61; H04W 12/63

(57) ABSTRACT

Techniques for restricting functionality of a user device are disclosed. A service restricts the functionality in response to a detection of a wireless signal emanating from a remote beacon device. The service detects the wireless signal emanating from the remote beacon device. In response to the detection of the wireless signal, the service restricts the functionality of the user device.

### CROSS-REFERENCE TO RELATED APPLICATIONS

This application claims the benefit of and priority to U.S. Provisional Patent Application Ser. No. 63/723,368 filed on Nov. 21, 2024 and entitled “RULE-BASED SYSTEM THAT RESTRICTS A USER DEVICE BASED ON A DETECTED CONDITION,” which application is expressly incorporated herein by reference in its entirety.

### BACKGROUND

The emergence of mobile devices has led to many significant improvements in many areas of life, such as work productivity, connection with others, safety, and so on. The complexity of mobile devices has greatly increased through time to the point where so-called “smart” mobile devices are now prevalent.

As used herein, a “smart” mobile device is a type of electronic device that includes the ability to connect to a network (e.g., such as the Internet or any other local wireless network) and that can process data, such as by using installed applications. One of the pinnacle moments in smart mobile device technology was the first release of Apple's iPhone in 2007. This first iPhone revolutionized the mobile device industry due to its improved usability and intuitive functionality. As smart mobile devices have improved, so too have their popularity. Smart mobile devices are now reaching younger and younger individuals; even young toddlers are now able to engage with smart mobile devices.

Although smart mobile devices provide significant benefits, they are not without their downfalls, particularly for young individuals. For example, FIG. 1 shows an example chart 100 listing the number of major depressive episodes in teens living in the United States. Chart 100 has as the X-axis the years starting at about year 2005. Chart 100 has as the Y-axis the number of major depressive episodes.

Starting around the year 2010, the so-called smart phone era 105 emerged. During this era, many youth started to use smart phones. Not coincidentally, the number of major depressive episodes also started to rise sharply during the smart phone era 105. Many mental health professionals speculate that the use of smart phones has had and will continue to have a profound negative impact on teens. In view of that speculation, there is a significant need to better control how smart phones are used, particularly by teens but also by all other categories of individuals. It is desirable to allow all individuals, including teens, to capitalize on the benefits that smart devices provide while also avoiding or mitigating the negative impact that smart devices can have on young individuals.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a computer system including: a processor system; and one or more hardware storage devices that store instructions that are executable by the processor system to cause the computer system to: host a service configured to restrict a functionality of the computer system, wherein the service restricts the functionality of the computer system in response to a detection of a wireless signal emanating from a remote beacon device that is remote relative to the computer system; cause the service to identify a condition in which a user of the computer system provides user input that turns off a wireless communication functionality of the computer system; in response to identifying the condition and in response to acquiring telemetry data, cause the service to use the telemetry data to determine that a location of the computer system is potentially within a threshold distance relative to the remote beacon device; cause the service to activate the wireless communication functionality that was previously turned off by the user, such that the service overrides the user input; cause the service to detect the wireless signal emanating from the remote beacon device; in response to the detection of the wireless signal, cause the service to restrict the functionality of the computer system, such that the functionality of the computer system is restricted based on the detection of the wireless signal emanating from the remote beacon device.

In some aspects, the techniques described herein relate to a method including: hosting, on a computer system, a service configured to restrict a functionality of the computer system, wherein the service restricts the functionality of the computer system in response to a detection of a wireless signal emanating from a remote beacon device that is remote relative to the computer system; causing the service to detect the wireless signal emanating from the remote beacon device; and in response to the detection of the wireless signal, causing the service to restrict the functionality of the computer system, such that the functionality of the computer system is restricted subsequent to the detection of the wireless signal emanating from the remote beacon device.

In some aspects, the techniques described herein relate to a handheld computing device including: a touchscreen; a processor system; and one or more hardware storage devices that store instructions that are executable by the processor system to cause the computer system to: host a service configured to restrict a functionality of the handheld computing device, wherein the service restricts the functionality of the handheld computing device in response to a detection of a wireless signal emanating from a remote beacon device that is remote relative to the handheld computing device; cause the service to detect the wireless signal emanating from the remote beacon device; in response to the detection of the wireless signal, cause the service to restrict the functionality of the handheld computing device, such that the functionality of the handheld computing device is restricted based on the detection of the wireless signal emanating from the remote beacon device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example chart listing the number of major depressive episodes for teens in the United States.

FIG. 2 illustrates an example computing architecture that can be used to provide enhanced protective measures with regard to the use of a smart mobile device.

FIG. 3 illustrates different protective measures that can be used at both the application-level of a smart mobile device and an operating system-level of the device.

FIG. 4 illustrates an example of a configuration scenario.

FIGS. 5, 6, 7, and 8 illustrate various different examples of user interfaces that can be used to configure the disclosed embodiments.

FIGS. 9, 10, 11, 12, and 13 illustrate different examples of use case scenarios in which the disclosed principles can be practiced.

FIG. 14 illustrates a flowchart of an example method for triggering the restriction of functionality of a smart mobile device.

FIG. 15 illustrates an example state machine for controlling entry into a restricted state.

FIG. 16 illustrates a progressive radio activation flow.

FIG. 17 illustrates a flowchart of an example method for restricting a user device.

FIG. 18 illustrates an example computer system that can be configured to perform any of the disclosed operations.

### DETAILED DESCRIPTION

As mentioned, there is a significant need to better control how smart phones are used, particularly by teens but also by all other categories of individuals. It is desirable to allow all individuals, including teens, to capitalize on the benefits that smart devices provide while also avoiding or mitigating the negative impact that smart devices can have on young individuals.

For instance, consider how students are currently performing in the classroom. Many students acknowledge that they are distracted due to their own phone usage. As another example, consider how prevalent distracted driving is due to phone usage, particularly text messaging, while driving. Some estimates say that text messaging while driving leads to less control over a vehicle than some individuals experience even when under the influence of alcohol or drugs. As another example, consider a scenario where adults lie in bed and play on their phones late into the night when they should otherwise be sleeping in preparation for the next day's activities.

The disclosed embodiments bring about significant benefits, improvements, and practical applications in how smart mobile devices are allowed to operate. Beneficially, the embodiments enable an intelligent service to be installed on a user device. This service can receive or adopt different policies or permissions that will govern the control of the user device. Such control can be had over any application installed on the user device or even over features of the operating system. By implementing the disclosed principles, the user device will be restricted in an intelligent and refined manner, thereby leading to increased productivity on the part of the user of the user device. Safety can also be improved, such as in the distracted driving scenario. Additionally, by limiting or restricting aspects of the user device, the disclosed embodiments can also operate to prolong the battery life of the user device, thereby making the device operate in a more efficient and prolonged manner.

The disclosed embodiments are distinct relative to traditional parental controls, screen time/focus/Do Not Disturb While Driving, MDM geofencing, and other control mechanisms. For instance, as will be described in more detail later, the disclosed embodiments beneficially offer progressive radio activation to force reconnection even when users attempt to toggle radio features off (e.g., cell triangulation to GPS to Wi Fi to BLE), with time of day heuristics. Such features are unique relative to generic screen time controls.

The embodiments also offer beacon attenuation to shape the physical envelope of restrictions (e.g., classroom walls/courtroom/lab boundary). The embodiments also provide operating system (OS) level input/output (I/O) gating (e.g., driver hooks/permission masks/screen capture interception), not just application blocking. Emergency exceptions and hands free substitution (e.g., safety critical flows while restricting texting), with explicit I/O path changes are also provided by the disclosed embodiments. Accordingly, these and numerous other benefits will now be described in more detail throughout the remaining portions of this disclosure.

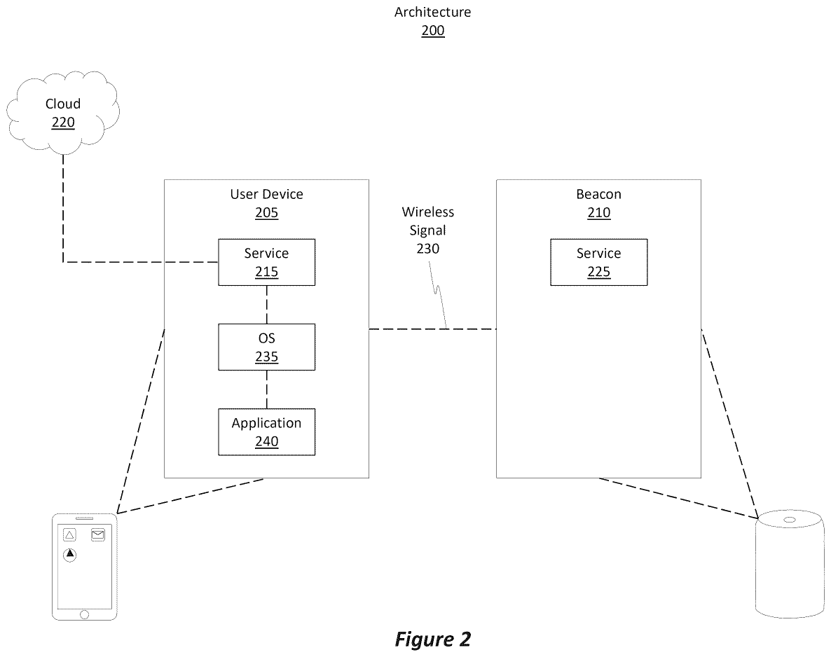

Having just described some of the high level benefits, advantages, and practical applications achieved by the disclosed embodiments, attention will now be directed to FIG. 2, which illustrates an example computing architecture 200 that can be used to achieve those benefits. Architecture 200 includes a user device 205 and an external/remote beacon 210, which is external relative to the user device 205 and which is also a computing device potentially having smart capabilities, though it is not necessary.

User device 205 may be any type of mobile smart device, such as any type of mobile smart phone or mobile smart tablet. User device 205 can also be implemented as a laptop, desktop, or any other computing device having smart abilities (i.e. the ability to connect to the Internet). In some scenarios, the beacon 210 is a unique device relative to both the user device 205 and any Wi-Fi router that the user device 205 is connected to. In other scenarios, the beacon 210 can be implemented as a part of the Wi-Fi router that the user device 205 is connected to. Therefore, while a majority of the disclosed examples are directed to a scenario involving a separate beacon, one will appreciate how the beacon can operate as a part of a network component, such as the Wi-Fi router.

User device 205 includes a first instance of a service 215. As used herein, the term “service” refers to an automated program that is tasked with performing different actions based on input. In some cases, service 215 can be a deterministic service that operates fully given a set of inputs and without a randomization factor. In other cases, service 215 can be or can include a machine learning (ML) or artificial intelligence engine. The ML engine enables service 215 to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 215 is a cloud service operating in a cloud 220 environment. In some implementations, service 215 is a local service operating on a local device, such as the user device 205. In some implementations, service 215 is a hybrid service that includes a cloud component operating in the cloud 220 and a local component operating on a local device. These two components can communicate with one another. Beacon 210 is also shown as including an instance of the service 225. Service 225 may be configured in the manner described above with respect to service 215.

Service 215, which is shown as being hosted by the user device 205, may be in communication with service 225, which is shown as being hosted by the beacon 210. This communication is shown via the wireless signal 230. It will be appreciated how any type of wireless connection may be used to facilitate the cross communication between service 215 and service 225. In some instances, the wireless signal 230 is made via any type of near field communication protocol, one example of which is a BLUETOOTH connection. The range of a BLUETOOTH connection may vary depending on different factors. In some scenarios, such as a BLUETOOTH 5.0 version or newer versions, the physical range for connecting devices using a BLUETOOTH connection can reach approximately 800 feet. In indoor situations, the physical range is often reduced due to signal obstructions.

Another example of the wireless signal 230 is a Wi-Fi connection, where the user device 205 is connected to the same router as the beacon 210. Thus, both devices (i.e. the user device 205 and the beacon 210) are operating on at least the same local area network.

Wireless functionality or wireless signals can include, but are not limited to, any type of cellular functionality or data (e.g., 3G, 4G, 5G, and so on), Wi-Fi, BLUETOOTH, NFC, infrared, or any other type of radar signal. Wireless functionality, as used herein, also includes GPS functionality or any type of location functionality. Accordingly, any type of wireless connection protocol can be used to facilitate the wireless signal 230.

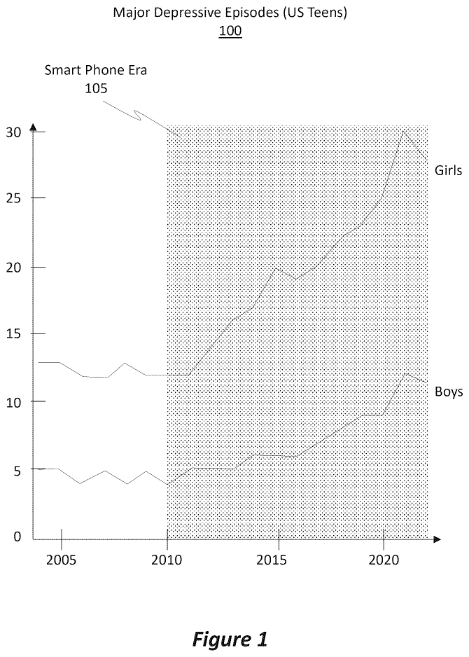

Service 215 is a client-side service tasked with controlling the functionality of the user device 205. By way of example, user device 205 may be a smart mobile phone used by a teenager. Service 215 is tasked with implementing various parental controls that operate to limit the functionality of the user device 205 in an effort to avoid the pitfalls mentioned earlier with respect to FIG. 1.

An administrator, such as a parent of the teenager, can configure a set of permissions that govern the operational behavior of the user device 205. As will be described in more detail shortly, these governing permissions may control any feature of the user device 205, including features provided by the operating system (OS) 235 of the user device 205 as well as any application 240 operating on the user device 205. The features can also control when the device will function (e.g., be turned on and off) and will control access to downloadable or streamed content, such as content obtained over the Internet or any type of application, including social media applications.

In accordance with the disclosed principles, these governing permissions are triggered when the user device 205 is brought within a threshold distance or proximity of the beacon 210. For instance, in response to the wireless signal 230 being made between the user device 205 and the beacon 210, service 215 may be activated or may be triggered to limit the functionality of the user device 205 in a pre-defined manner or potentially in a dynamic manner. The connection between the beacon 210 and the user device 205 can be performed automatically and without user involvement after an initial relationship, pairing, or subscription is formed between the two devices.

Reference is made within this disclosure to various terms and phrases. These terms and phrases should be interpreted in a broad manner. For context, however, this passage provides some example implementations as to how some of these terms and phrases can be interpreted. For instance, the terms/phrases “threshold distance/proximity/sufficient proximity” can be defined based on a received signal strength indicator (RSSI) window or number, link budget, number of consecutive detections, and/or triangulated error bounds. “Restricted state/safe mode/kiosk-like constraints” can be used to determine which OS features are disabled and which classes of applications are visible/hidden. “Non-critical notifications” can describe notifications outside a policy-enumerated high-priority channel list (e.g., emergency alerts, guardian numbers, enterprise safety topics). “Dummy signal” can describe a non-paired broadcast (e.g., BLUETOOTH low energy (BLE) advertising frame) that contains no user data and that is used solely for zone delineation. “Near field wireless communication protocol” can refer to BLUETOOTH/BLE, near field communication (NFC), and even Wi-Fi.

As an example, suppose the beacon 210 is positioned within the classroom of a teacher, and suppose the wireless signal 230 is made via a BLUETOOTH connection. When a student possessing the user device 205 comes within a sufficient proximity of the beacon 210 to establish the BLUETOOTH connection, then service 215 is automatically triggered to activate the governing permissions. These permissions may restrict the student's ability to use the user device 205, thereby helping the student pay attention better while in class.

In some scenarios, an initial configuration operation is performed to enable the BLUETOOTH connection between the user device 205 and the beacon 210. For instance, the two devices may be paired with one another during the initial configuration operation. This initial pairing will permit the two devices to communicate with one another during later periods of time. Similarly, during the initial configuration operation, the service 215 may be downloaded onto the user device 205.

In some instances, service 215 may be configured to limit the ability of the user of user device 205 to turn on or off the wireless connection features, such as the BLUETOOTH feature. If, for example, the user had the ability to turn off the user device's BLUETOOTH feature, then the user could potentially avoid service 215 being triggered in response to the wireless signal 230 being made or detected. Thus, some embodiments configure service 215 to have the ability to restrict a user's ability to turn on or off a wireless setting.

In another scenario, service 215 may include location detection abilities. Service 215 may also include information detailing the physical location (e.g., using GPS data) of the beacon 210, where that physical location may be predefined and made known to service 215. Service 215 may track the location of user device 205. When service 215 determines that user device 205 is within a threshold distance relative to beacon 210, service 215 may then start the restriction on the ability to turn on or off the wireless setting. Additionally, or alternatively, service 215 may forcefully turn on the wireless setting so that the signal from the beacon 210 can be detected. Thus, this restriction on wireless settings may not be continuous but rather may be implemented when service 215 determines that user device 205 is within a threshold distance relative to beacon 210.

As an example, consider a classroom scenario in which the disclosed principles are being employed. Some students may not want their devices to be connected to the beacon (e.g., because they do not want to pay attention to the class), so those students might attempt to preemptively turn off the BLUETOOTH feature on their phones prior to coming within the threshold distance of the beacon 210. In such a scenario, service 215 on the user device 205 can rely on the GPS data to determine that the user device 205 is within the beacon 210's threshold proximity. In response, service 215 can then automatically turn on the BLUETOOTH feature on user device 205, thereby facilitating the connection with the beacon 210. Thus, even if a user attempts to circumvent the BLUETOOTH connection, service 215 includes sufficient logic to automatically turn on the BLUETOOTH connection.

In another scenario, the user might turn off the GPS on his/her phone as well as the BLUETOOTH in another attempt to avoid connecting with the beacon 210. Additionally, the user might turn off the Wi-Fi connections for the phone. In such a scenario, service 215 can estimate an approximate location of the user device 205 based on triangulation relative to the available cell phone towers.

In another scenario, the service 215 can determine the time of day and the current day of the week. If the timestamp data reflects a time when the user would normally be at school, service 215 can determine again that the user is potentially trying to avoid having the user device 205 connect to the beacon 210.

Service 215 can then automatically turn on the GPS on the user device 205 to determine a more accurate location of the user device 205. If service 215 determines that user device 205 is again within the threshold distance of the beacon 210, then service 215 can activate the BLUETOOTH option on the user device 205, thereby facilitating the connection to the beacon 210. Thus, some embodiments can employ a multi-step process to determine whether to facilitate a connection with the beacon 210. That is, some embodiments will progressively activate certain features of the user device 205 in an attempt to gain further information regarding the status or location of the user device 205. As more information is obtained, where that information indicates a likelihood that the user device 205 is within the threshold distance of the beacon 210, additional features will be activated until such time as the near field communication protocol (e.g., BLUETOOTH) is activated and a connection with the beacon 210 is made.

In the example above, the progressive and step-wise activation of features included first using a telecommunications feature of the user device 205 to determine a triangulated position of the user device 205 and/or determine timestamp information and whether the date/time corresponds to a date/time when a student would normally be in school. Subsequently, the embodiments activated the GPS abilities and/or the Wi-Fi abilities of the user device 205. Subsequently, the embodiments activated the near field wireless communication protocol to facilitate an eventual connection with the beacon 210. In some scenarios, the embodiments may skip a number of the above steps and instead proceed to directly turn on the near field wireless communication protocol so as to facilitate the connection between the user device 205 and the beacon 210. Accordingly, there are various procedures and mechanisms available to facilitate or potentially even force a connection between the user device 205 and the beacon 210. In some rare circumstances, the user may even turn off the telecommunication abilities of the user device 205, such as by setting the user device 205 to airplane mode. In such a scenario, the user is restricting the user device 205 him/herself, and thus already achieving one objective of the user device 205, which objective is to limit the functionality of the user device 205 while in a given scenario (e.g., a classroom scenario).

In some implementations, service 215 comprises: (i) a proximity aggregator that computes a proximity score S(t) from a sliding window of received signal strength indicator (RSSI) samples, a geofence predicate, and motion cues; (ii) an enforcement manager that applies OS-level permission masks (e.g., camera, microphone, screen-capture, clipboard, keyboard, etc.) and intercepts app-launch intents; (iii) a radio controller that executes a progressive activation policy (e.g., cell-triangulation to Wi-Fi scan to GPS fix to BLUETOOTH scan) with programmable thresholds, hysteresis, and energy budgets; and (iv) a policy store that indexes beacon identifiers to enforcement profiles and emergency-exception whitelists.

As used herein, “hysteresis” is a control-system concept describing how a system's response to a changing input depends not only on the current value of the input, but also on its recent history. In other words, the system uses different thresholds for entering and exiting a state, which prevents rapid toggling (i.e. “chatter”) when the input fluctuates near a boundary. Hysteresis can be used to stabilize transitions between device states (e.g., “restricted” and “unrestricted”) based on sensor readings, signal strength, or other evidence.

The progressive activation policy may operate as follows: if S(t)<T₁, where T₁ is a first threshold, no restrictions apply. If S(t)∈[T₁,T₂) trigger Wi-Fi scan; if still inconclusive, enable GPS with a maximum dwell time Δ. Upon S(t)≥T₂, where T₂ is a second threshold, enable BLUETOOTH scanning. If a target beacon is detected with RSSI≥Rₘᵢₙ for N consecutive intervals, transition to restricted state and apply the profile associated with the beacon ID. On exit, require RSSI≤R_{low} for M intervals (hysteresis) before restoring to the unrestricted state. Regarding the “profile,” the profile can include the rules and restrictions that are to be imposed against the user device.

An optional LLM agent (to be described in more detail later) may observe telemetry data (e.g., failed-open attempts, motion state, time-of-day) and propose profile adjustments via a constrained action schema (e.g., add/remove applications from a whitelist; tighten/loosen a feature mask) that are validated by the enforcement manager prior to application.

When a wireless signal 230 is detected and/or established, service 215 may then communicate with service 225. Optionally, other permissions or settings can be input to service 225, and when the wireless signal 230 is made, service 225 may transmit those permissions to service 215 for implementation on user device 205. As one example, a teacher may use his/her phone to connect to the beacon 210. The teacher may then define certain permissions that are then pushed to the service 225. Subsequently, service 225 may push these permissions to the service 215 when a student's phone comes within proximity to the beacon 210.

In other implementations, beacon 210 may actually omit service 225 and may simply send out a wireless signal. When service 215 detects this wireless signal, service 215 may then be triggered to implement the governing permissions. In some scenarios, the wireless signal can be a dummy signal that simply operates as an indication that the user device 205 is sufficiently close to the beacon 210 so as to detect the wireless signal. In other scenarios, the wireless signal can include some data or instructions that are used by the service 215. Thus, in some scenarios, service 215 can operate in concert with service 225 while in other scenarios service 215 may operate without involvement of service 225 and instead may be triggered simply in response to the detection of the wireless signal 230. That is, it is not a requirement that a paired relationship be established between user device 205 and beacon 210. Stated differently, an actual pairing connection may not be needed between user device 205 and beacon 210; instead, simply the detection of an output signal from beacon 210 may be sufficient to trigger service 215 to begin restricting the functionality of user device 205.

Accordingly, in some embodiments, service 215 is triggered in response to a paired connection with beacon 210 being established. In some embodiments, service 215 is triggered in response to detection of an output wireless signal being propagated from beacon 210, and it may be the case that no pairing connection is established between the user device 205 and the beacon 210.

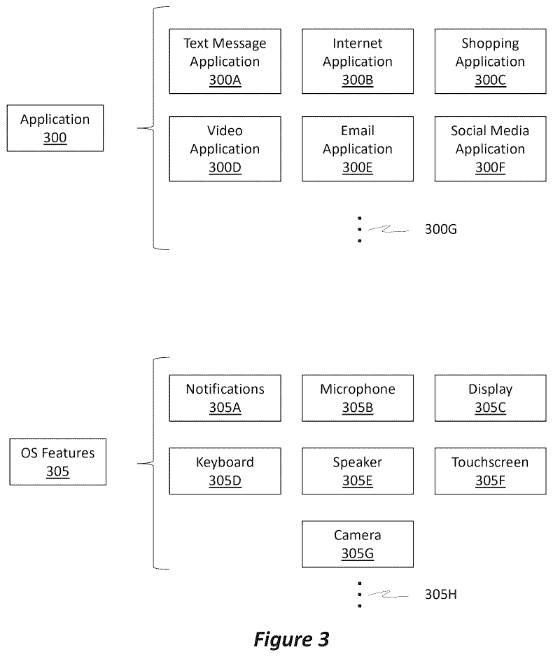

When service 215 is triggered (e.g., caused by the detection of the wireless signal 230), service 215 operates to restrict the functionality of the user device 205. In some implementations, the functionality of the device's OS 235 is limited. In some implementations, the functionality of one or more applications, such as application 240, is limited. In some implementations, the functionality of the OS 235 and the functionality of the application 240 are both limited. In some instances, the user device 205 is caused to be placed in a powered down state or a sleep state for a predefined period of time (e.g., any period of time from about 1 minute to about 90 minutes) or until the wireless signal 230 is no longer active. FIG. 3 provides some examples of applications and examples of restrictions that can be implemented by service 215.

FIG. 3 shows an application 300, which is representative of the application 240 of FIG. 2. FIG. 3 shows a non-exhaustive list of example applications that may be governed by service 215. For instance, application 300 may be implemented as a text message application 300A, an internet application 300B, a shopping application 300C, a video application 300D, an email application 300E, and a social media application 300F. The ellipsis 300G demonstrates how any other application may be included among this list.

Service 215 is able to limit or restrict all or some of the functionality of application 300 in any manner. For instance, service 215 may force application 300 to remain in an off state (or otherwise non-functional or restricted state) during the period of time in which service 215 detects proximity to beacon 210. Service 215 may force application 300 to remain in a different state as well, such as a paused state, a sleep state, or any other state where a user's interaction with application 300 is restricted.

Referring back to the student classroom example, suppose application 300 is implemented as the text message application 300A and suppose the user device 205 is in the classroom with sufficient proximity to the beacon 210 such that the wireless signal 230 is detected and service 215 is triggered. In some embodiments, service 215 may restrict the text message application 300A in a manner so that new text message notifications will be turned off or even so that the text message application 300A is caused to remain in an off state. In the event the student attempts to open the text message application 300A, service 215 can intercept that open operation and prevent the text message application 300A from opening on the user device 205.

Optionally, service 215 may restrict notifications of any kind (including text messages) from anybody other than the user's parents. In some scenarios, the user may still be able to contact his/her parents (or the police, such as by calling 911) via any communication protocol (e.g., phone, text, Wi-Fi calling, etc.) at any time, even when the wireless signal 230 is detected. Such an option may be beneficial in emergency scenarios so the user can communicate with his/her parents (or the police) in the event of an emergency.

Consider another example scenario involving a person driving a vehicle. Here, the vehicle includes the beacon 210. While the person is driving the vehicle, service 215 limits the functionality of the user device 205. For instance, the text message application 300A may operate in a restricted or prohibited state or mode, such that the person will not be able to view text messages while the user device 205 is within the vehicle due to its proximity to the beacon 210. One will appreciate how distracted driving from text messages is a serious problem. Implementing the principles disclosed herein can help mitigate distracted driving. In this scenario, user device 205 may be permitted only to call (but not text) his/her parents or the police. Optionally, when a call is made, the call can be a hands-free call by causing the call to be played over the loudspeaker of the user device 205 so the call can be a hands-free call.

Service 215 can limit the states, modes, or functionalities of the other example implementations of application 300 in FIG. 3. For instance, the social media application 300F may be prohibited from being used, opened, or even be prohibited from displaying notifications while the student is in the classroom (or is proximate to the beacon), due to the proximity between the user device 205 and the beacon 210.

Service 215 can also limit the functionality of OS features 305 of the user device, as shown in FIG. 3. Examples of OS features 305 that can be limited include notifications 305A, the microphone 305B, the display 305C, the keyboard 305D, the speaker 305E, the touchscreen 305F, or any hard buttons on the device, or the camera 305G. The ellipsis 305H demonstrates how other OS features may be included in this list.

As an example, service 215 may restrict any or specific types of notifications 305A from being displayed on the user device 205. In some scenarios, it may be beneficial to permit notifications of a certain type to be displayed, such as emergency alert notifications. Service 215 may include intelligence to determine the type or subject matter of the notification, and may permit certain types of notifications to be displayed to the user. As another example, service 215 may include intelligence for analyzing the subject matter of a text message, and may determine that the text message is relaying an emergency from a family member. In such a scenario, a notification of this text message, as well as the text message itself, may be surfaced/displayed to the user. Other, non-emergency text messages can be limited by preventing their display, as least for a period of time (e.g., until the wireless signal 230 is lost).

Any type of notification may be governed by the service 215. For instance, notifications from any of the applications included among application 300 may be governed.

The user device's microphone 305B may also be restricted. Thus, the ability of the user to have his/her voice captured by the user device can be controlled. If the user knows he/she cannot record a message, such as on a social media application, the user may determine that it is not worthwhile to use his/her phone during the time period while the user device 205 is in proximity to the beacon 210.

The user device's display 305C can also be limited. In some scenarios, the display 305C may be turned off. Similarly, the keyboard 305D may be deactivated. Similarly, the speaker 305E of the device may be turned off. The touchscreen 305F features of the display may also be turned off. Optionally, the display 305C may still be operational but the touchscreen ability of the display may be limited. Optionally, the device's camera (e.g., camera 305G) can be turned off. Accordingly, service 215 is able to control different OS features 305 of the user device 205 while the user device 205 is within proximity to the beacon 210. Any one or combination of the above can be combined with any one or combination of other features, without limit.

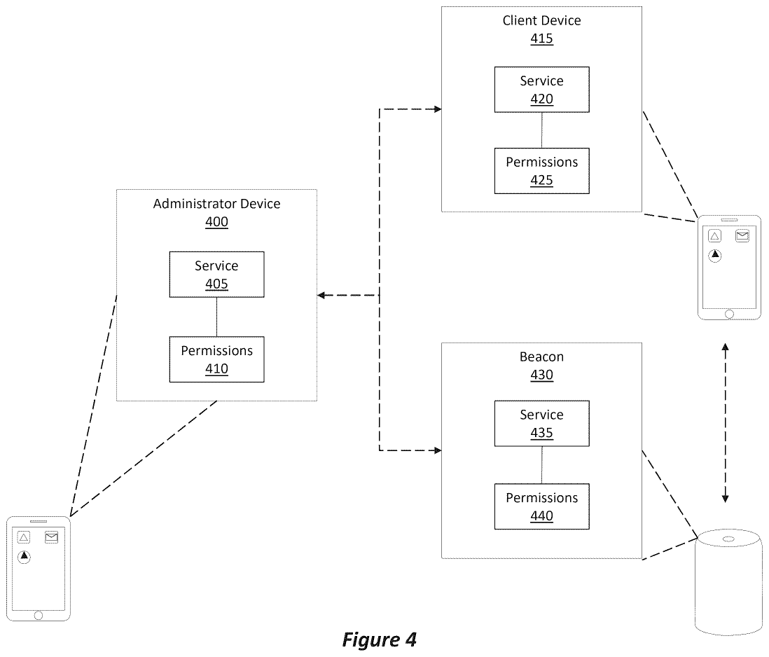

FIG. 4 illustrates one example scenario regarding how service 215 of FIG. 2 may be configured to implement governing permissions. In some implementations, an administrator device 400 (e.g., perhaps a parent device) includes the service 405, which may be used to establish or define a set of permissions 410 that are to be implemented on another device, or potentially even the administrator device 400 itself. For instance, an adult may desire to limit his/her own phone during certain scenarios, such as the driving scenario mentioned earlier. Thus, the permissions 410 may be used to govern another device, such as the client device 415, or the permissions 410 may be used to govern the administrator device 400.

The client device 415, in one scenario, is representative of the user device 205 of FIG. 2. Service 405 may be in communication (via any communication protocol) with the service 420. The permissions 410 defined on the administrator device 400 may then be propagated or transmitted to the client device 415, as shown by permissions 425, for implementation by the service 420. In another scenario, the permissions 425 may be received over a network connection from a cloud node, which may receive the permissions 410 from the administrator device 400.

In another scenario, administrator device 400 may be in communication with the beacon 430, which is representative of the beacon 210 of FIG. 2. Beacon 430 may also include an instance of the service 435. Service 405 on the administrator device 400 may communicate with service 435 on the beacon 430. Service 405 may transmit the permissions 410 to the beacon 430, as shown by permissions 440.

When the client device 415 is brought within sufficient proximity of the beacon 430, service 420 may communicate with service 435. In one scenario, service 435 may transmit the permissions 440 to the client device 415 for implementation by service 420, as shown by permissions 425. Thus, the permissions may be transmitted from the administrator device 400 to the client device 415 either via a direct line of communication between the administrator device 400 and the client device 415 or via an indirect line of communication from the administrator device 400 to the beacon 430 and then to the client device 415. The cloud scenario mentioned earlier is also illustrative of an indirect line of communication. The permissions 410 may govern the behavior of any of the applications illustrated in FIG. 3 and/or any of the OS features 305.

In some scenarios, different conditions can trigger the application of different permissions. For instance, when a user device is brought into a classroom, heightened restrictions on the device might be implemented. Alternatively, when the device is brought into a home scenario, some restrictions might still be used, but those restrictions might be less than the restrictions used in the classroom scenario.

Optionally, some embodiments employ the use of a large language model (LLM) agent. A “large language model” (LLM) is a specialized type of machine learning (ML) or artificial intelligence (AI) model that has been trained on a large set of data. The data can be of any type, though it is often text-based data. Image data, video data, and other data types can also be used. With its training, the LLM is able to understand and produce output that resembles human-generated output. As various examples, an LLM can be tasked with translating input from one language (e.g., perhaps English) to another language (e.g., perhaps Spanish). LLMs can be tasked with answering questions, writing code, analyzing language patterns, and writing creative content. LLMs can be involved with an “agent.”

An “agent” is a type of system or service that leverages one or more LLMs to perform a task, which refers to a unit of work that needs to be performed. Notably, an agent is a type of autonomous system that can “think” and act on its own; meaning, it can operate without specific instructions from a user. An LLM will respond to a question if asked. For instance, if an LLM is asked: “What is the price of a plane ticket to Machu Pichu?” the LLM can generate a response. An agent, on the other hand, can not only provide a response, but it can also go about scheduling and paying for the flight. The agent can also book a hotel and vehicular travel arrangements.

An agent operates on top of an LLM in that the agent can use the LLM to complete its tasks. An agent also includes memory and tools or functionality. Using its memory, the agent can recall information from past sessions. Using its tools, the agent can facilitate the completion of tasks, such as the scheduling mentioned above. Agents can have access to external databases, application programming interfaces (API), or any other utility. At its highest level of description, however, an agent can be viewed as being an executable service or component having access to an LLM that operates at the core of the agent. The LLM helps to process information and to assist in deciding what decisions will be taken by the agent. Additional memory, action-taking skills, or tools can be plugged into the agent to further expand its functionality.

An agent can be tasked with operating as defensive agent to help control the user device. These defensive agents can proactively think on their own and recognize (e.g., in real time) that a given restriction should be implemented or that a given restriction can be removed. The defensive agent can then act on its own to control the device, such as by restricting the device or removing restrictions from the device. Advantageously, the agent does not need human intervention such that these defensive agents are autonomous systems. The agents can thus generate governing rules, and modify those rules, over time based on the behavior of the user and the current situation in which the user device is being employed.

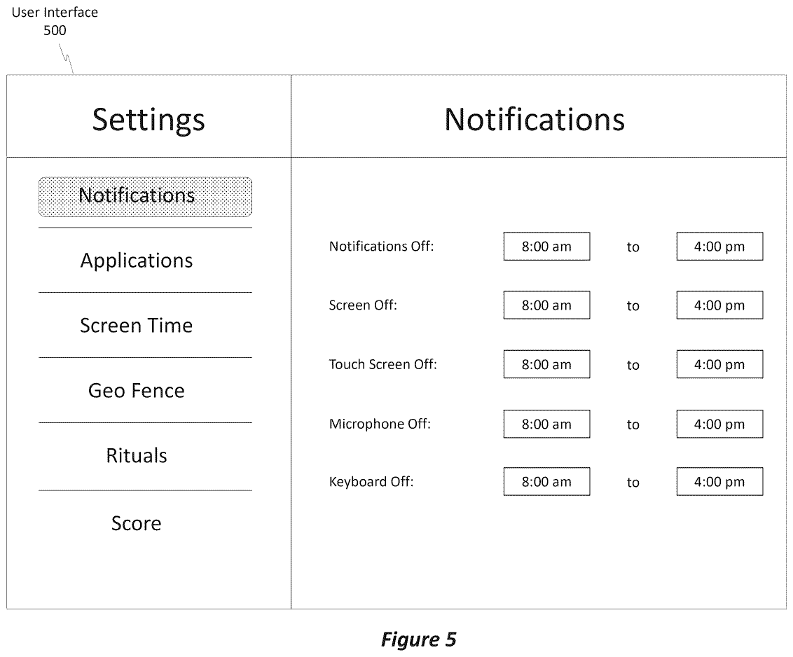

FIGS. 5, 6, 7, and 8 illustrate various different user interfaces that may be used to configure the disclosed services, such as by establishing the permissions described herein. These user interfaces can also display various use metrics, which may guide an administrator in determining what permissions are warranted. In some instances, an initial time period may be used to determine a user's baseline behavior with respect to the user device 205. For instance, the baseline behavior may indicate that the user does not use his/her user device while in school, but the user is very active on the user device during bedtime hours. Such use may negatively impact the user because of the lack of sleep. Thus, user behavior data can be acquired during an initial tracking time period in which the user's behavior is observed and patterns of behavior are detected. Optionally, the LLM agent mentioned earlier can perform this behavior tracking.

FIG. 5 shows an example user interface 500 that an administrator may use to establish the permissions described above. User interface 500 includes multiple configuration tabs that are usable to configure different aspects of a particular user device. In particular, these configuration tabs are listed on the left-hand side of the user interface 500 and include the following: notifications, applications, screen time, geo fence, rituals, and score.

User interface 500 currently shows how the notifications tab is being displayed. This tab allows an administrator to dictate when certain OS features of the device, particularly notifications, will be available to a user. For instance, in FIG. 5, all notifications are turned off during the time period between 8:00 am and 4:00 pm, which coincides with schooltime hours. One will appreciate how a more granular definition can be made, such as which specific days of the week the notifications will be turned off or whether holidays or weekends are to be included during these time periods.

User interface 500 also shows how other OS features may be controlled. These other features include the screen, the touch screen, the microphone, the camera, and the keyboard, among others. User interface 500 may include options for defining multiple different time periods within a single day. For instance, instead of a hard 8:00 am to 4:00 pm limit, user interface 500 allows an administrator to define multiple time periods, such as perhaps from 8:00 am to 12:00 pm and then from 1:00 pm to 4:00 pm, thereby allowing the user of user device to see notifications during the lunch hour.

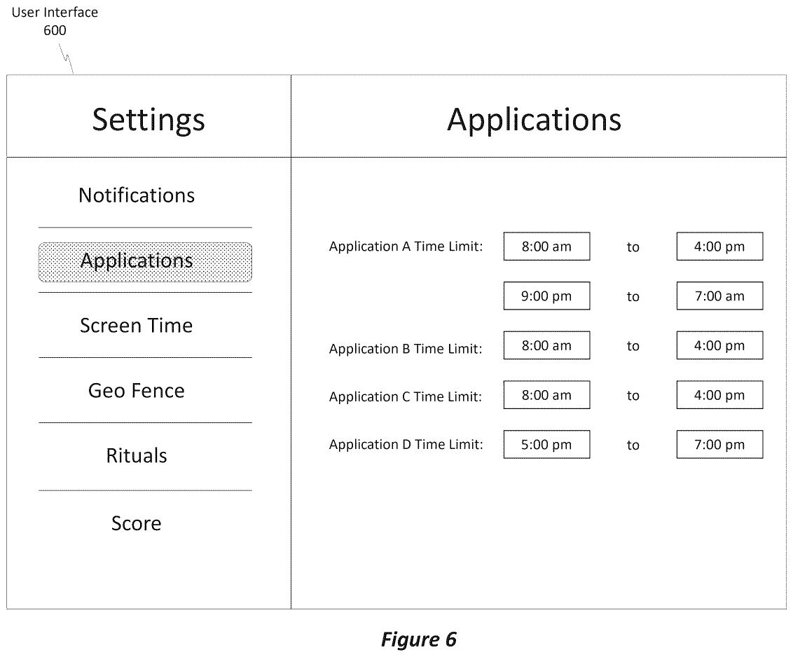

FIG. 6 shows an example user interface 600 where the applications tab is currently active. In this scenario, specific applications can be listed, and their functionality can be limited. In some cases, a granular definition as to how an application may be limited can be defined. For instance, in one scenario, application “A” may be restricted in its entirety such that during a defined time period, application “A” is wholly unavailable to the user of the user device. In another scenario, application “B” may be restricted only in part, such as by having one or more specific features of application “B” limited but allowing one or more other specific features of application “B” to remain operational and available to the user. In some scenarios, instead of listing specific applications that are to be limited, some embodiments list specific applications that are allowed, and all other applications are, by default, restricted. Thus, some embodiments include a restrictions list (i.e. a blacklist) while other embodiments include an allow list (i.e. a whitelist).

As one example, consider a hands-free scenario involving a driver of a car. In this implementation, the service may restrict a text message from being displayed on the user's phone while the user is driving, but the service may permit the text message to be read aloud to the user while the user is driving. Similarly, the service may restrict the user's ability to respond to the text message by typing on the phone, but the service may permit the user to use a voice-to-text feature to draft and send a response text message. Thus, the user may be permitted to interact with the phone using verbal commands and may be restricted from interacting with the phone in a physical manner.

FIG. 6 shows an example scenario when specific time periods are listed to restrict the user device's functionality. Alternative options are also available. For instance, user interface 600 (or any of the user interfaces described herein) may restrict notifications, applications, or any other user device functionality in response to the detection of the beacon and perhaps without regard to a specific time period. Thus, when proximity to the beacon is established, the applications or notifications may be limited even if a defined time period is not established, as shown in FIG. 6. In some scenarios, the permissions may be triggered when the beacon is positioned in a vehicle and when GPS data indicates that the vehicle is moving. If the vehicle is not moving, then the restrictions may be lifted.

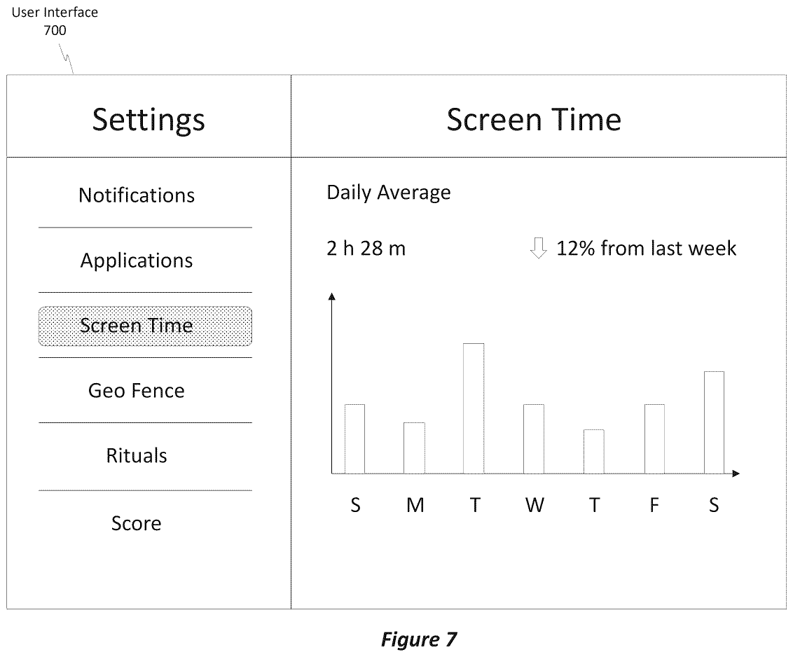

FIG. 7 shows an example user interface 700 providing data on user behavior, such as the daily average use of a user device. User interface 700 may also indicate comparative metrics, such as the relative usage of the user device this week as compared to last week.

The disclosed user interfaces also allow an administrator to define a geofence. Thus, a geofence boundary can also be implemented by the disclosed embodiments in addition to or as a substitute for the beacons described herein. The user interfaces also allow an administrator to define various rituals during which a user device's functionality may be restricted. For example, one ritual may include dinner time with the family. Another ritual may include sleep hours. Another ritual may include religious services. Any ritual may be defined, and limitations on the user device may be imposed during those rituals.

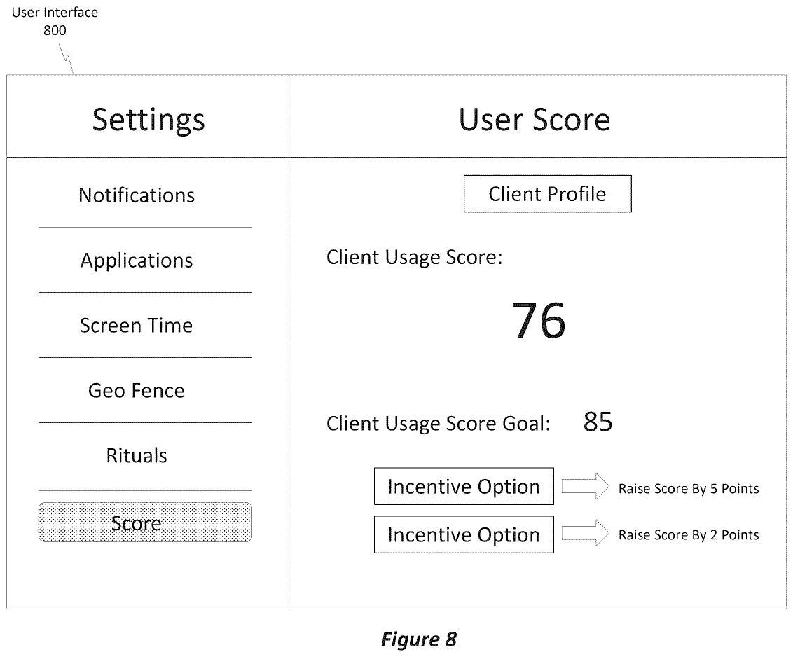

FIG. 8 shows a user interface 800 that lists a defined user score for a given user profile. The user score may be based on the detected user behavior of the user. For instance, it might be the case that even though the user's user device is operating in a restricted mode, the user still attempts to engage with the device as opposed to focusing his/her full attention on a different matter (e.g., perhaps classroom instruction). These fruitless engagements can be monitored, and they can be used to generate a score for the user. Similarly, the score may be based on other detected behaviors of the user, even during times when the user device is not operating in a restricted state. Optionally, the administrator can define certain incentive options that, if performed by the user, will operate to increase the user's score by a defined amount.

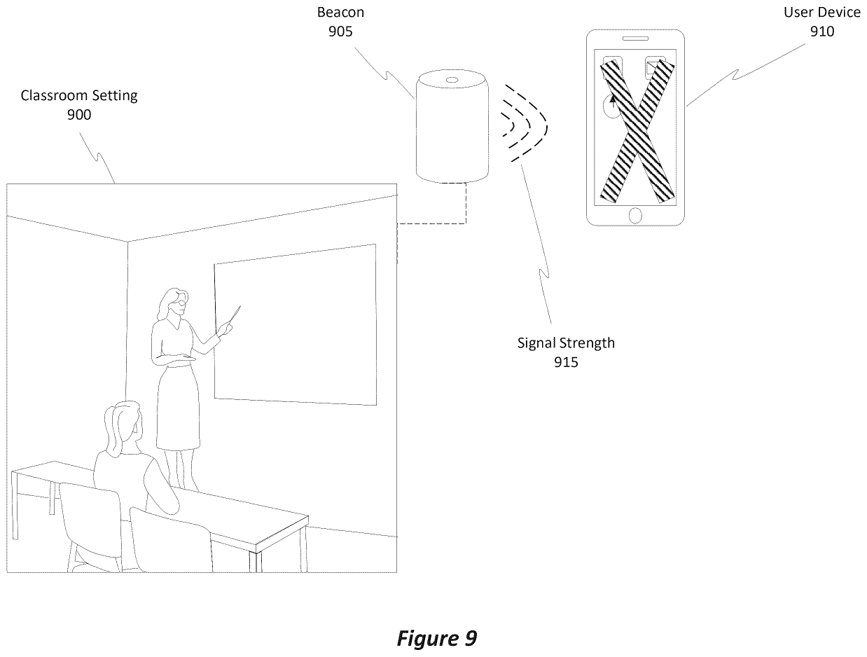

FIGS. 9, 10, 11, 12, and 13 illustrate various example use case scenarios in which the disclosed principles can be employed. These use case scenarios are but a small sample of scenarios in which these principles can be practiced.

FIG. 9 shows a classroom setting 900 in which the principles can be practiced. The classroom may be equipped with a beacon 905. When a student enters the classroom with a user device 910 (or rather, comes within a threshold distance of the beacon 905), the user device 910 will detect the signal emanating from the beacon 905. The service operating on the user device 910 will then be triggered to restrict the functionality of the user device 910 in the manner described previously. The large “X” on the user device 910 represents the restriction on the functionality of the user device 910. The restrictions may be predefined, as mentioned earlier.

In some scenarios, restricting the user device 910 can include displaying a message on the user device 910 to inform the user that the user device 910 is operating in a restricted mode. For instance, the message can read: “This device is operating in a restricted mode” or something similar.

In some implementations, beacon 905 can be configured in a manner so that the emanating signal is attenuated, or rather, so that the signal strength is reduced, as shown by signal strength 915. In some scenarios, beacon 905 can attenuate the signal strength so that the signal substantially propagates only a desired distance before it falls off and is not detectable. For instance, classrooms are typically not overly large. The beacon 905 may attenuate the signal strength 915 in a manner so the signal falls off after the user device 910 leaves the classroom. Thus, some embodiments can control a signal strength of the signal emanating from the beacon 905.

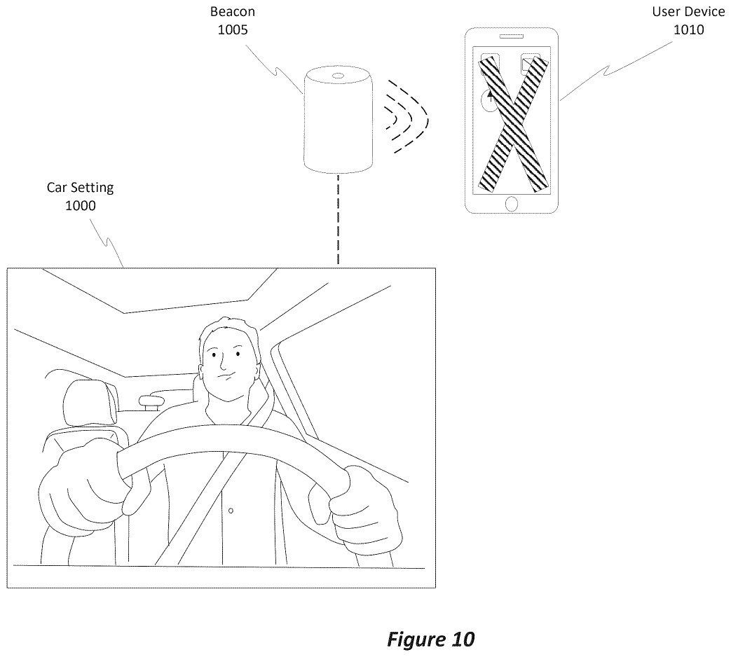

FIG. 10 shows an example of a car setting 1000 in which a beacon 1005 and a user device 1010 are operating. Because the beacon 1005 travels with the car (and potentially is powered by the car), the beacon 1005 can help restrict the functionality of the user device 1010 when the user device 1010 is in proximity to the car. In some scenarios, one or more applications may be limited (e.g., perhaps a text messaging application) while one or more other applications may be permitted (e.g., perhaps a navigation application). Optionally, the GPS car driving instructions application of the user device 1010 may be permitted to remain active while other applications can be restricted. As another option, the hands-free talking option for a call can be permitted. The text messaging, email, social media, and other applications can all be restricted, including any notifications from those applications. Notifications might be delayed or restricted from being displayed or otherwise surfaced to the user until such time as the restrictions are removed.

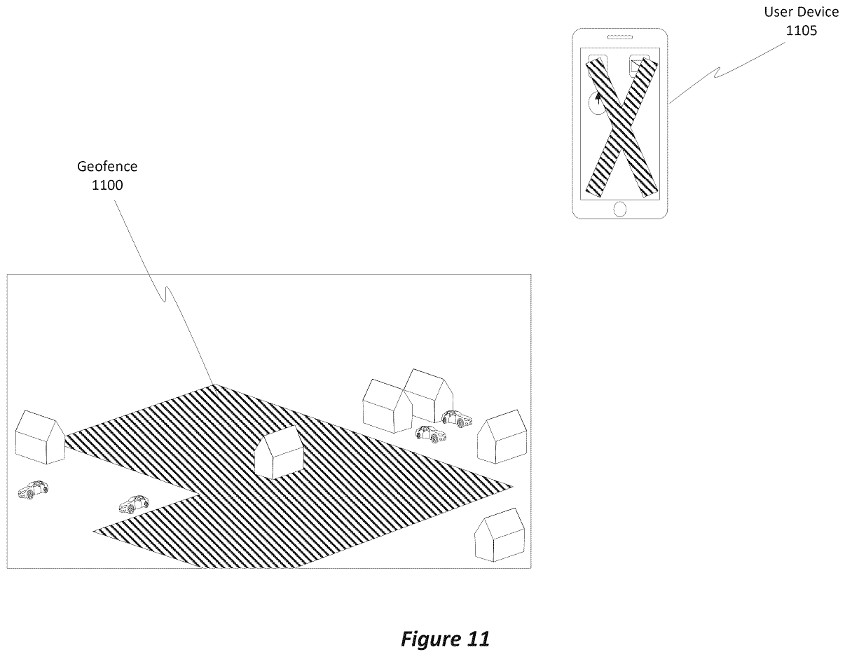

FIG. 11 shows an example of a geofence 1100 implementation involving the user device 1105. Here, when the user device 1105 is brought within the boundary defined by the geofence 1100, the functionality of the user device 1105 is limited, despite the absence of a beacon.

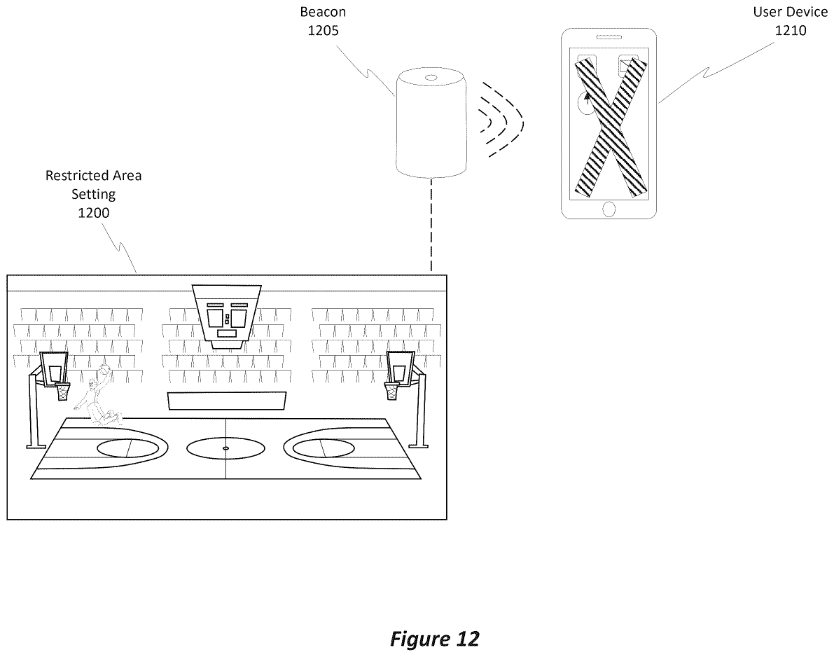

FIG. 12 shows an example of a restricted area setting 1200 involving a beacon 1205 and a user device 1210. In this example, the restricted area setting 1200 is that of a basketball arena. Optionally, the disclosed principles can be used to control content or applications that are available to user devices when they enter a given premises or area.

As one example, due to copyright protections, the arena may desire to restrict users from being able to record. Enforcement of that prohibition, however, has been historically very challenging. In accordance with the disclosed principles, the arena can now require use of the disclosed service to enter the arena. For instance, the availability of a ticket may be limited only if the service is installed on each patron's user device. With the service then installed, the user will be able to access his/her ticket to gain entrance into the arena. Similarly, with the service installed, the service can then limit the user device's ability to record video or audio or to capture images. Thus, the disclosed principles can be used to help safeguard data or events occurring within a given area.

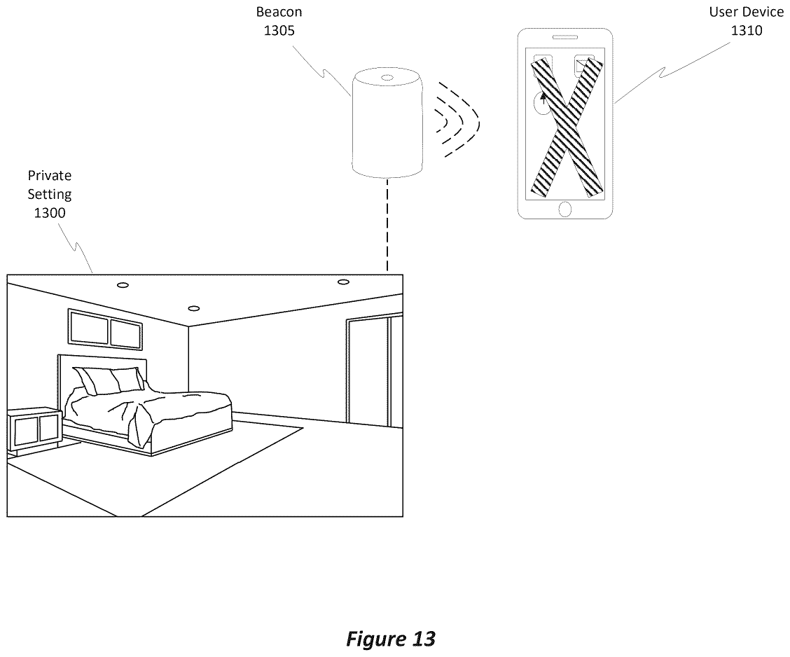

FIG. 13 shows a private setting 1300 in the form of a bedroom. Recent studies have shown that it is generally recommended to not use a user device within 1-2 hours of a person going to sleep. A beacon 1305 can be disposed in the private setting 1300, and the user device 1310 can have its functionality limited at scheduled time periods and when the user device 1310 is within a threshold proximity of the beacon 1305.

Thus, the functionality of a user device can be limited in various ways. In some scenarios, the functionality is limited in response to the user device being within a proximity to a beacon. In some scenarios, the functionality of the user device may not be limited until a scheduled time despite the user device being within the threshold distance relative to the beacon. Accordingly, disclosed herein are numerous different ways in which the user device may be restricted.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

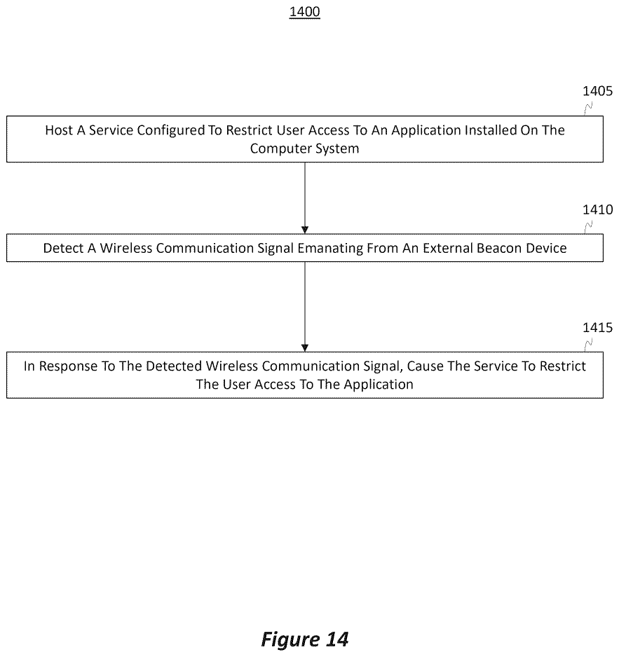

Attention will now be directed to FIG. 14, which illustrates a flowchart of an example method 1400 for dynamically restricting the functionality of a user device. Method 1400 can be implemented within the architecture 200 of FIG. 2. Method 1400 can be performed using service 215.

Method 1400 includes an act (act 1405) of hosting a service. This service is configured to restrict user access to an application installed on a computer system, such as a user device. Additionally, or alternatively, the restriction may be directed to a feature of the operating system of the user device. In some scenarios, a first user device can send an invite to a second user device to invite the second user device to use the disclosed service. For instance, a teacher may require her students to use the service while the students are in the teacher's classroom. Thus, in some scenarios, an ad hoc invite or quick join invite can be used. Optionally, the quick join invite may be in the form of a URL, a scannable QR code, a tap option on the beacon device, or any other invite implementation.

Act 1410 includes detecting a wireless communication signal. This signal is emanating from an external beacon device that is external and remote relative to the user device. In some scenarios, the user device and the beacon may form a paired relationship. In other scenarios, the disclosed operations may be triggered simply from the detection of the wireless communication signal, even if no pairing relationship is formed.

Act 1415 includes causing, in response to the detected wireless communication signal, the service to restrict the user access to the application and/or to the OS feature. This restriction may be performed in any manner or to any degree. In some scenarios, the restriction is such that use of the user device is essentially made unavailable. In other scenarios, the restriction is more granular and impacts only specific OS features, applications, or application features while allowing other OS features, applications, or application features to be available.

### Additional Practical Applications, Benefits, and Improvements

In some embodiments, when a user device is detected within a beacon-defined secure boundary, the service transitions the device into a data-restriction mode that disables one or more OS features (e.g., camera, microphone, clipboard, screen capture) and suppresses non-critical notifications. If the user attempts to defeat radio detection, the service progressively activates location and short-range radios to re-establish proximity evidence and to re-apply restrictions. The beacon's transmit strength can be tuned so the restricted mode ends substantially at the lab envelope.

On entry to a designated restriction zone, personal devices auto-enter “safe” mode: screenshots, camera, and unapproved cloud-backup channels are disabled. Optionally, only whitelisted secure apps remain visible; emergency-call exceptions stay enabled. As one example, upon detecting proximity to a healthcare facility beacon or entry into a geofenced area, the service enables a healthcare privacy mode. This mode disables screenshot capture and camera access, prevents background synchronization to non-approved cloud services, surfaces only approved clinical apps, and preserves emergency calling.

As another example, consider trading floors or PCI zones (i.e. regulated finance zones). Within a trading floor's proximity boundary, the device enforces kiosk-like constraints: blocks consumer messaging/social apps, disables screen-recording and copy/paste from finance apps, and filters push notifications to eliminate “unsanctioned tip” channels—reverting automatically when outside the zone. Accordingly, the embodiments use a non-conventional arrangement (e.g., edge beacon and device service) to filter/limit content based on location-specific policy, thereby implementing an architectural improvement. As another example, in some implementations, an enterprise designates “regulated zones” (e.g., trading floors) where the service automatically suppresses consumer messaging, disables screen-recording and clipboard export, and permits only approved trading clients and authenticator apps while the device remains within beacon range.

The disclosed principles can also be employed in data centers and server rooms to facilitate anti-exfiltration and safety. For instance, within a co-location or server room, the service places personal devices in an access-controlled state that disables optical and audio capture, restricts third-party app networking, and preserves only identity/authenticator functions for check-in/out workflows.

Courthouse beacons can trigger a proceedings-integrity mode in which local recording and network sharing are temporarily disabled and only authorized judicial apps are surfaced; the beacon's output can be attenuated so the restricted mode is limited to courtrooms and jury areas.

In a test proctoring scenario, detection of a testing-center beacon causes the device to enter an exam posture that disables screen capture, copy/paste, and third-party messaging, while exposing only a whitelisted test application. Emergency calling can remain available.

The embodiments also encourage workplace safety. For instance, when the device is proximate to industrial safety beacons (e.g., in a machine bay), the service enforces hands-free interaction, disables non-essential input/output features, and elevates plant alerts over personal notifications to reduce distraction risk.

To further illustrate how the embodiments substantially improve computer functionality, it should be noted how the embodiments provide: (a) driver/OS-level hooks that change how the device services I/O when a beacon is present; (b) state-machine options for restriction transitions with defined timing bounds; (c) cache/network throttles that modify how applications fetch data while restricted; and (d) an indexed table that maps beacon IDs to sensor/feature profiles maintained locally for offline enforcement.

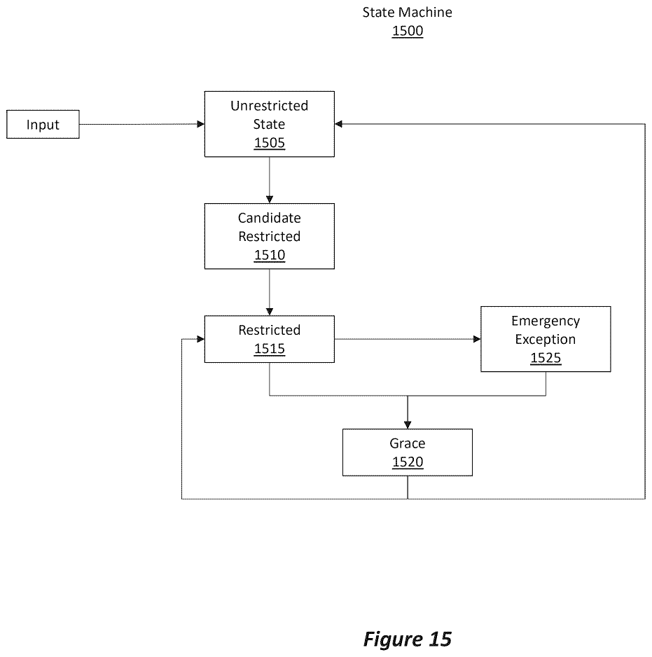

FIG. 15 illustrates a restriction state machine 1500 that governs device enforcement postures based on proximity evidence, timers, and hysteresis. As used herein, “hysteresis” refers to the use of distinct entry and exit thresholds for a state transition, such that the system enters a state (e.g., restricted) only when a measured parameter (e.g., proximity evidence score) meets or exceeds a high threshold (R_{H}), and exits that state only when the parameter falls below a lower threshold (R_{L}), where R_{H}>R_{L}. This prevents rapid toggling of states due to minor fluctuations in the measured parameter. A “hysteresis pair” is the combination of the entry threshold (R_{H}) and exit threshold (R_{L}) used to control transitions into and out of a state.

The machine includes an unrestricted state 1505, a candidate-restricted transitional state 1510, a restricted state 1515 in which an enforcement profile is applied, and a grace state 1520 used to prevent oscillation when leaving the restricted posture. A proximity evidence input S(t) (e.g., included in “input”) is computed (e.g., by a proximity aggregator) from one or more observations, such as beacon RSSI windows, geofence inclusion, and device motion.

When S(t) meets or exceeds a high threshold R_{H} from a hysteresis pair (R_{H}, R_{L}) for at least N consecutive samples enforced by transition guards, the machine transitions from unrestricted 1505 to candidate-restricted 1510 and starts an enter timer τₑₙₜₑᵣ. If S(t) remains at or above R_{H} through expiry of τₑₙₜₑᵣ, the machine enters restricted 1515; otherwise it returns to unrestricted 1505. While restricted 1515, an enforcement profile is selected by an enforcement-profile selector (e.g., based on a detected beacon identifier) and applied to operating-system resources.

Exit from restricted 1515 is qualified by hysteresis: when S(t) is at or below R_{L} for M consecutive samples, the machine transitions to grace state 1520 and starts a grace timer τ_{grace}; if S(t) remains at or below R_{L} through expiry of τ_{grace}, the machine returns to unrestricted 1505, otherwise it re-enters restricted 1515. Optional geofence and motion predicates may further condition transitions. An emergency exception path 1525 allows predetermined emergency interactions (e.g., 911 or guardian communications) without changing the current state. Violation events (e.g., attempts to toggle radios or launch disallowed applications while restricted) may be recorded and/or used to tighten enforcement within restricted 1515. The structure and operation of the state machine 1500 provides a concrete mechanism for the embodiments to compute a proximity condition, transition among defined device states under control of timers and hysteresis, and, in response, apply or relax OS-level restrictions in a non-oscillatory manner.

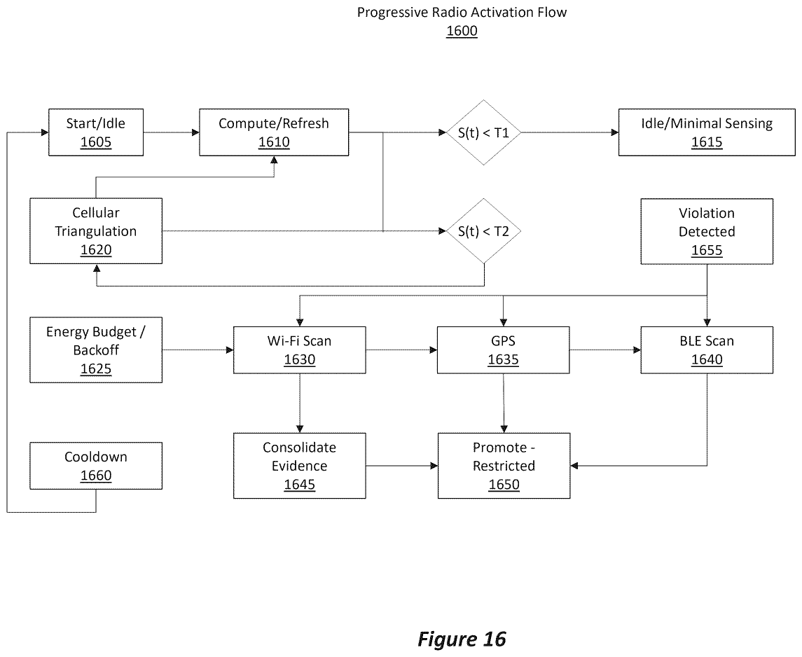

FIG. 16 depicts a progressive radio activation flow 1600 that consolidates proximity evidence before promotion to the restricted posture. The flow begins at start/idle 1605, where a proximity evidence score S(t) is computed or refreshed (e.g., compute/refresh 1610) from available signal observations.

If S(t) is below a lower threshold T₁, the device maintains minimal sensing for beacon signals 1615. When S(t) is between T₁ and a higher threshold T₂, the system performs low-energy cellular triangulation 1620 and re-evaluates S(t) (e.g., compute/refresh 1610).

Subject to an energy-budget and backoff manager 1625, the system may escalate incrementally or sequentially to a Wi-Fi scan 1630 (with interval I_{wifi} and dwell Δ_{wifi}), then to a GPS acquisition attempt 1635 (with maximum dwell Δ_{gps} and accuracy target), and then to a BLE scan 1640 (with scan interval I_{BLE} and window W_{BLE}) seeking a target beacon identifier with RSSI≥R_{H} sustained for N intervals. If any escalation step yields S(t)≥T₂ or a qualifying beacon match, an evidence consolidation decision 1645 is made and the device promotes to the restricted state, as shown by promote—restricted 1650.

If user interference or a violation is detected (e.g., violation detected 1655) (e.g., radios manually disabled), the flow escalates to the next tier (e.g., any of Wi-Fi scan 1630, GPS acquisition attempt 1635, or BLE scan 1640).

When S(t) remains below T₁ for K consecutive cycles, a cooldown 1660 reduces sensing and returns to idle. By specifying thresholds T₁/T₂, hysteresis R_{H}/R_{L} (used by the state machine), explicit scan intervals and dwell bounds (I_{wifi}, Δ_{wifi}, Δ_{gps}, I_{BLE}, W_{BLE}), and an energy-budget/backoff manager 1625, the flow 1600 provides a concrete “detect and escalate” mechanism that the embodiments can employ to detect wireless communication conditions and, in response to consolidated proximity evidence, cause the service to restrict user access.

In some embodiments, a beacon interface receives non-paired wireless advertisements and related signals and supplies them to a proximity aggregator, which computes the proximity evidence score S(t) from inputs such as RSSI windows, geofence inclusion, and motion. A state machine engine consumes S(t) and drives transitions among unrestricted, candidate-restricted, restricted, and grace states using timers and hysteresis.

When the restricted state is active, an enforcement manager applies the selected enforcement profile by invoking OS driver hooks to disable or limit one or more features (e.g., camera, microphone, screen capture, clipboard, keyboard/touch input) and by intercepting application-launch intents to allow only applications enumerated in a whitelist.

An OS driver hook refers to a technique used to intercept and potentially modify the behavior of operating system-level functions, especially those related to device drivers and system events. In computing, hooking is a method of intercepting function calls, messages, or events passed between software components. When applied to device drivers or the operating system (OS), a driver hook allows the service to: monitor system-level operations (e.g., I/O requests, keyboard/mouse input), modify or redirect how the OS or driver handles those operations, or even inject custom logic before or after the original function executes. This is often done by replacing or wrapping the original function with a custom one, called a hook procedure.

The disclosed service can implement driver hooks in various ways. In one example, the service can implement API hooking, which involves intercepting calls to system APIs (e.g., Windows API functions) by modifying the import table or using wrapper libraries. Service can also implement virtual method table (VMT) hooking, which alters pointers in a class's virtual method table to redirect function calls to custom handlers. Service can also implement runtime hooking, which involves injecting hooks into memory while the application is running. Service can also implement SetWindowsHookEx, which involves installing a hook procedure into a hook chain to intercept system messages like keystrokes or mouse movements.

A radio controller implements the progressive radio activation flow 1600 of FIG. 16, including energy-budget and backoff management, and feeds updated observations back to the proximity aggregator.

A policy store maintains index mapping beacon identifiers to enforcement profiles specifying application whitelists, feature masks, and notification policies. The state machine engine and enforcement manager retrieve the active profile from the policy store upon entry to the restricted posture. An emergency exception handler permits predefined emergency interactions without clearing the restricted state.

A telemetry logger records attempted violations and timing/energy statistics for audit or adaptive tuning, while an admin configuration interface accepts configuration updates (e.g., permissions, quick-join enrollment). In certain implementations, an optional agent module proposes bounded edits to enforcement profiles under a constrained action schema. A notification filter may prioritize emergency or enterprise channels and defer non-critical alerts while restricted.

### Additional Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

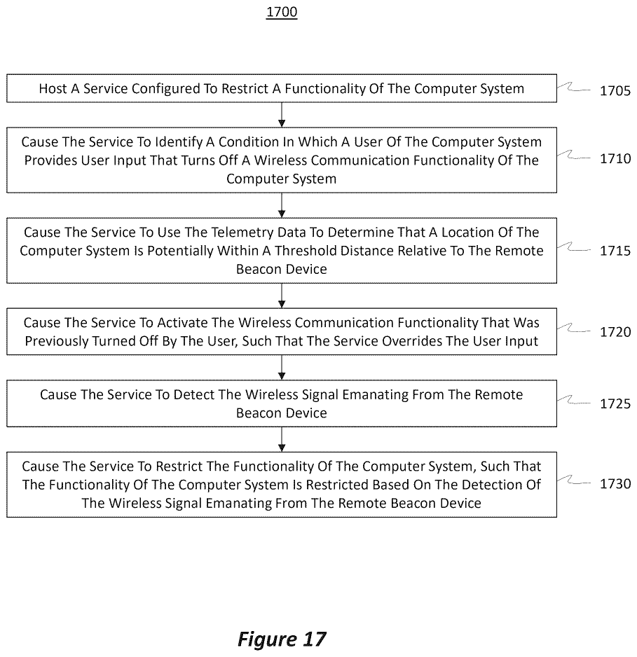

Attention will now be directed to FIG. 17, which illustrates a flowchart of an example method 1700 for restricting the functionality of a computing device. Method 1700 can also be performed within the architecture 200 of FIG. 2 and by service 215.

Method 1700 includes an act (act 1705) of hosting a service (e.g., service 215 of FIG. 2) configured to restrict a functionality of a computer system (e.g., user device 205). The service restricts the functionality of the computer system in response to a detection of a wireless signal (e.g., wireless signal 230) emanating from a remote beacon device (e.g., beacon 210) that is remote relative to the computer system.

Act 1710 includes causing the service to identify a condition in which a user of the computer system provides user input that turns off a wireless communication functionality of the computer system. In some scenarios, the wireless communication functionality that the user turns off is one of: a near field wireless communication protocol connection (e.g., BLUETOOTH or BLE or NFC), a Wi-Fi connection, or a cellular telecommunications connection. Optionally, the user might activate the “airplane” mode of the device. Although traditionally GPS function might not typically be considered a “wireless functionality” of a smart device (e.g., because GPS does not transmit data wireless; rather, it only receives satellite data), as used herein, a GPS function should be considered as a wireless functionality.

In response to identifying the condition and in response to acquiring telemetry data, act 1715 includes causing the service to use the telemetry data to determine that a location of the computer system is potentially within a threshold distance relative to the remote beacon device. In some scenarios, the threshold distance is about 10 meters, so as to align with class 2 BLUETOOTH devices. In some scenarios, the telemetry data includes at least one of: global positioning system (GPS) data, timestamp data, received signal strength indicator (RSSI) data, or cellular base station data.

Act 1720 includes causing the service to activate the wireless communication functionality that was previously turned off by the user. That is, the service overrides the user input. Optionally, service might also turn on other wireless communication functionality.

In some implementations, prior to activating the wireless communication functionality, the service triggers a progressive radio activation process. This process can include one or more or any combination of the following actions. One action involves the service determining a current date and time and, in response to the current date and time, activating the wireless communication functionality. For instance, it might be that the current date and time reflect that the user of the device should currently be in school. In response, service activates the BLUETOOTH function in an attempt to determine whether the user's device is within the threshold distance of the beacon.

Another action involves the service determining global positioning system (GPS) data. In response to the GPS data indicating that the computer system is potentially within the threshold distance, the service activates the wireless communication functionality.

Another action involves the service triangulating the location of the computer system using cellular base station data. In response to the service determining that the computer system is potentially within the threshold distance, the service activates the wireless communication functionality.

Act 1725 includes causing the service to detect the wireless signal emanating from the remote beacon device. In some scenarios, the computer system does not have a paired relationship with the remote beacon device. As such, the wireless signal emanating from the remote beacon device can be a dummy signal. In other scenarios, the computer system does have a paired relationship with the remote beacon. As such, the wireless signal emanating from the remote beacon device can be a paired broadcast signal.

In response to the detection of the wireless signal, act 1730 includes causing the service to restrict the functionality of the computer system, such that the functionality of the computer system is restricted based on the detection of the wireless signal emanating from the remote beacon device. Optionally, the functionality of the computer system includes functionality pertaining to an operating system (OS) of the computer system or an application executing on the computer system. The functionality of the computer system can include functionality pertaining to an input or output feature of the computer system, where the input or output feature includes a keyboard of the computer system, a microphone of the computer system, a speaker of the computer system, a display of the computer system, or a camera of the computer system.

In some scenarios, the user may try to circumvent some of the location-based actions by implementing a virtual private network (VPN). The embodiments can cause the service to determine that a virtual private network (VPN) is active on the computer system, such as by querying the OS to determine whether a VPN application is active on the system. In response to determining that a VPN is active, service can terminate the VPN.

In some scenarios, restricting the functionality of the computer system includes restricting notifications from being displayed by the computer system. Optionally, the functionality of the computer system is restricted for a predetermined threshold amount of time, such as a set number of minutes or hours. Optionally, restricting the functionality of the computer system includes restricting user access to multiple applications installed on the computer system, including especially social media applications. In some scenarios, restricting the functionality of the computer system includes restricting blacklisted applications from operating on the computer system while allowing whitelisted applications to operate on the computer system. Optionally, restricting the functionality of the computer system includes restricting subsequent user input directed to attempts to turn off one, some, all, or any wireless communication functionalities.

The computer system can be a handheld computing device that includes a touchscreen. Optionally, restricting the functionality of the handheld computing device includes turning off the touchscreen.

Optionally, the beacon can operate as a source of information to the authority figure (e.g., perhaps the teacher). For instance, if a student is attempting to hide a device that is not connected to the beacon, the beacon can include a display showing a listing of all pinged devices that are within the threshold distance of the beacon but that are not currently connected to the beacon or following the policy of the beacon. For instance, if a device is detected and is not a paired device with the beacon, the beacon's display can display the name of the user device. The teacher can then examine the name to determine if the device is potentially one of her students. The teacher can then confiscate the device or require the student to pair the device with the beacon.

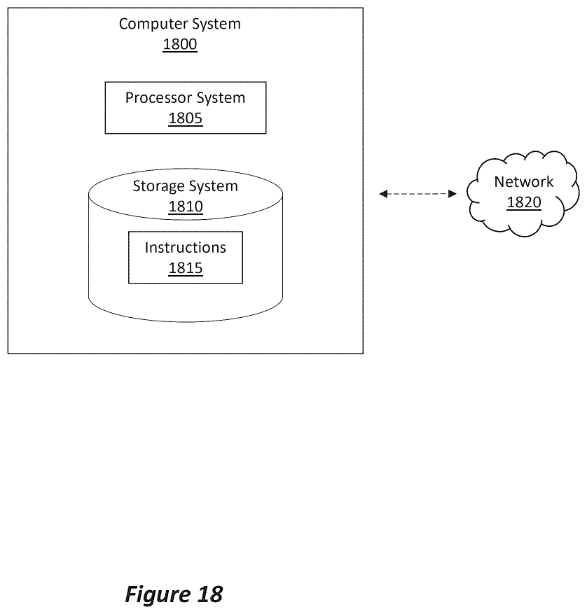

Attention will now be directed to FIG. 18 which illustrates an example computer system 1800 that may include and/or be used to perform any of the operations described herein. Computer system 1800 may take various different forms. For example, computer system 1800 may be embodied as a tablet, a desktop, a laptop, a mobile device, or a standalone device, such as those described throughout this disclosure. Computer system 1800 may also be a distributed system that includes one or more connected computing components/devices that are in communication with computer system 1800.

In its most basic configuration, computer system 1800 includes various different components. FIG. 18 shows that computer system 1800 includes a processor system 1805 comprising one or more processor(s) (aka a “hardware processing unit”) and a storage system 1810.

Regarding the processor(s) of the processor system 1805, it will be appreciated that the functionality described herein can be performed, at least in part, by one or more hardware logic components. For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 1800. The different components, modules, engines, and services described herein may be implemented as objects or processors that execute on computer system 1800 (e.g. as separate threads).

Storage system 1810 may be physical system memory, which may be volatile, non-volatile, or some combination of the two. The term “memory” may also be used herein to refer to non-volatile mass storage such as physical storage media. If computer system 1800 is distributed, the processing, memory, and/or storage capability may be distributed as well.

Storage system 1810 is shown as including executable instructions 1815. The executable instructions 1815 represent instructions that are executable by the processor(s) of computer system 1800 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 1800 may also be connected (via a wired or wireless connection) to external sensors (e.g., one or more remote cameras) or devices via a network 1820. For example, computer system 1800 can communicate with any number devices or cloud services to obtain or process data. In some cases, network 1820 may itself be a cloud network. Furthermore, computer system 1800 may also be connected through one or more wired or wireless networks to remote/separate computer systems(s) that are configured to perform any of the processing described with regard to computer system 1800.

A “network,” like network 1820, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 1800 will include one or more communication channels that are used to communicate with the network 1820. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

It should be noted that any feature recited herein may be combined with any other feature recited herein. Any feature illustrated in a particular Figure can be combined with any other feature illustrated in any of the other Figures. Thus, unless explicitly stated otherwise, the disclosed features, functions, operations, and characteristics are not mutually exclusive with any other features, functions, operations, or characteristics.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system comprising:
a processor system; and
one or more hardware storage devices that store instructions that are executable by the processor system to cause the computer system to:
host a service configured to restrict a functionality of the computer system, wherein the service restricts the functionality of the computer system in response to a detection of a wireless signal emanating from a remote beacon device that is remote relative to the computer system;
cause the service to identify a condition in which a user of the computer system provides user input that turns off a wireless communication functionality of the computer system;
in response to identifying the condition and in response to acquiring telemetry data, cause the service to use the telemetry data to determine that a location of the computer system is potentially within a threshold distance relative to the remote beacon device;
cause the service to activate the wireless communication functionality that was previously turned off by the user, such that the service overrides the user input;
cause the service to detect the wireless signal emanating from the remote beacon device;
in response to the detection of the wireless signal, cause the service to restrict the functionality of the computer system, such that the functionality of the computer system is restricted based on the detection of the wireless signal emanating from the remote beacon device.

2. The computer system of claim 1, wherein the functionality of the computer system includes functionality pertaining to an operating system (OS) of the computer system or an application executing on the computer system.

3. The computer system of claim 1, wherein the functionality of the computer system includes functionality pertaining to an input or output feature of the computer system, the input or output feature including a keyboard of the computer system, a microphone of the computer system, a speaker of the computer system, a display of the computer system, or a camera of the computer system.

4. The computer system of claim 1, wherein the wireless communication functionality that the user turns off is one of: a near field wireless communication protocol connection, a Wi-Fi connection, a cellular telecommunications connection, or a global positioning system (GPS) functionality.

5. The computer system of claim 1, wherein the telemetry data includes at least one of: global positioning system (GPS) data, timestamp data, received signal strength indicator (RSSI) data, or cellular base station data.

6. The computer system of claim 1, wherein the instructions are further executable to cause the computer system to:
cause the service to determine that a virtual private network (VPN) is active on the computer system; and
terminate the VPN.

7. The computer system of claim 1, wherein the threshold distance is about 10 meters.

8. The computer system of claim 1, wherein, prior to activating the wireless communication functionality, the service triggers a progressive radio activation process, which includes at least one of:
the service determining a current date and time and, in response to the current date and time, activating the wireless communication functionality; or
the service determining global positioning system (GPS) data and, in response to the GPS data indicating that the computer system is potentially within the threshold distance, activating the wireless communication functionality; or
the service triangulating the location of the computer system using cellular base station data and, in response to the service determining that the computer system is potentially within the threshold distance, activating the wireless communication functionality.

9. The computer system of claim 1, wherein restricting the functionality of the computer system includes restricting notifications from being displayed by the computer system.

10. The computer system of claim 1, wherein the functionality of the computer system is restricted for a predetermined threshold amount of time.

11. A method comprising:
hosting, on a computer system, a service configured to restrict a functionality of the computer system, wherein the service restricts the functionality of the computer system in response to a detection of a wireless signal emanating from a remote beacon device that is remote relative to the computer system;
causing the service to detect the wireless signal emanating from the remote beacon device; and
in response to the detection of the wireless signal, causing the service to restrict the functionality of the computer system, such that the functionality of the computer system is restricted subsequent to the detection of the wireless signal emanating from the remote beacon device.

12. The method of claim 11, wherein restricting the functionality of the computer system includes restricting user access to a plurality of applications installed on the computer system.

13. The method of claim 11, wherein restricting the functionality of the computer system includes restricting blacklisted applications from operating on the computer system while allowing whitelisted applications to operate on the computer system.

14. The method of claim 11, wherein the wireless signal emanating from the remote beacon device is a dummy signal.

15. The method of claim 11, wherein the wireless signal emanating from the remote beacon device is a paired broadcast signal.

16. The method of claim 11, wherein the computer system has a paired relationship with the remote beacon device.

17. The method of claim 11, wherein the computer system does not have a paired relationship with the remote beacon device.

18. The method of claim 11, wherein restricting the functionality of the computer system includes restricting subsequent user input directed to turning off any wireless communication functionalities.

19. A handheld computing device comprising:
a touchscreen;
a processor system; and
one or more hardware storage devices that store instructions that are executable by the processor system to cause the computer system to:
host a service configured to restrict a functionality of the handheld computing device, wherein the service restricts the functionality of the handheld computing device in response to a detection of a wireless signal emanating from a remote beacon device that is remote relative to the handheld computing device;
cause the service to detect the wireless signal emanating from the remote beacon device;
in response to the detection of the wireless signal, cause the service to restrict the functionality of the handheld computing device, such that the functionality of the handheld computing device is restricted based on the detection of the wireless signal emanating from the remote beacon device.

20. The handheld computing device of claim 19, wherein restricting the functionality of the handheld computing device includes turning off the touchscreen.
